(19) United States
(12) Patent Application Publication
(10) Pub. No.: US 2016/0189291 A1
(43) Pub. Date: Jun. 30, 2016

(54) MULTI-LENDER SERVICING OF A CREDIT ALLOWANCE

(71) Applicant: EBAY, INC., San Jose, CA (US)

(72) Inventor: Rahul Nair, San Jose, CA (US)

(21) Appl. No.: 14/585,252

(22) Filed: Dec. 30, 2014

(51) Int. Cl. G06Q 40/02; G06Q 20/40; G06Q 20/24

(52) U.S. Cl. CPC G06Q 40/025; G06Q 20/405; G06Q 20/24

(57) ABSTRACT

Methods, systems, and computer program products for providing multi-lender servicing of a credit allowance are disclosed. A computer-implemented method may include receiving a request to provide a credit allowance for a payment account, analyzing a payment history associated with the payment account, determining a credit allowance for the payment account, notifying a user of the determined credit allowance, requesting offers from a plurality of lenders to finance a first portion of the credit allowance, receiving user acceptance of an offer from a first lender to finance the first portion of the credit allowance, requesting offers from a plurality of lenders to finance a second portion of the credit allowance, receiving user acceptance of an offer from another lender to finance the second portion of the credit allowance, updating available credit for the credit allowance in view of the accepted offers of the different lenders.

### TECHNICAL FIELD

The present disclosure generally relates to computer systems and, more particularly, to providing multi-lender servicing of a credit allowance using computer systems.

### BACKGROUND

A line of credit generally describes a credit source provided by a government, business, individual, bank, or other source of financing. Various types of credit lines include overdraft protection, demand loans, term loans, discounting, purchase of commercial bills, and traditional revolving credit card accounts.

Currently, a business or consumer may request a single line of credit for an account, such as a merchant account or payment processing account. However, financing of such accounts is provided only once by a single lender under one set of terms and conditions. Thus, businesses and consumers are unable to secure additional funding with different or more favorable terms and conditions from other lenders for the same account, for example, when needed at a later time.

### BRIEF DESCRIPTION OF THE DRAWINGS

Various examples of the present disclosure will be understood more fully from the detailed description given below and from the accompanying drawings of various examples of the disclosure. In the drawings, like reference numbers may indicate identical or functionally similar elements. The drawing in which an element first appears is generally indicated by the left-most digit in the corresponding reference number.

FIG. 1 is a block diagram illustrating a system architecture, in accordance with various examples of the present disclosure.

FIG. 2 is a flow diagram for providing multi-lender servicing of the same credit allowance, according to an example of the present disclosure.

FIG. 3 is a flow diagram for performing processing of multi-lender servicing of the same credit allowance, according to an example of the present disclosure.

FIG. 4 is a block diagram of an exemplary computer system that may perform one or more of the operations described herein.

### DETAILED DESCRIPTION

Systems, methods, and computer program products are disclose for providing multi-lender servicing of a credit allowance.

In an example, a payment service provider provides an account to a user, such as a business or consumer. The user requests a credit allowance for the payment account. In response, the payment service provider determines whether to provide a credit allowance for the account by analyzing payment history of the account. The payment service provider then provides the credit allowance for the account. In some examples, the credit allowance provided for the account allows the user to borrow funds from different lenders, for example, at different times and under different terms and conditions.

In an example, the payment service provider receives a request from a user to use a first portion of the credit allowance to complete a first transaction. The payment service provider then sends servicing requests to each of one or more lenders requesting bids to finance the first portion of the credit allowance requested by the user. The payment service provider receives one or more bids from the lenders, provides the bids to the user, and receives user acceptance of one of the bids. The payment service provider then deducts the amount of the first portion of the credit allowance from an amount of available credit remaining on the credit allowance.

In an example, the payment service provider receives a new request from the user to use a second portion of the credit allowance to complete a subsequent transaction. The payment service provider then sends a second set of servicing requests to each of one or more lenders requesting bids to finance the second portion of the credit allowance. The payment service provider receives one or more new bids from the lenders, provides the new bids to the user, and receives user acceptance of one of the new bids. The payment service provider then deducts the amount of the second portion of the credit allowance from the amount of available credit remaining on the credit allowance.

Accordingly, aspects of the present disclosure provide users with the convenience and flexibility of obtaining different lines of credit under the same credit allowance for different transactions where each separate line of credit under the credit allowance may be financed by different lenders under different sets of terms and conditions.

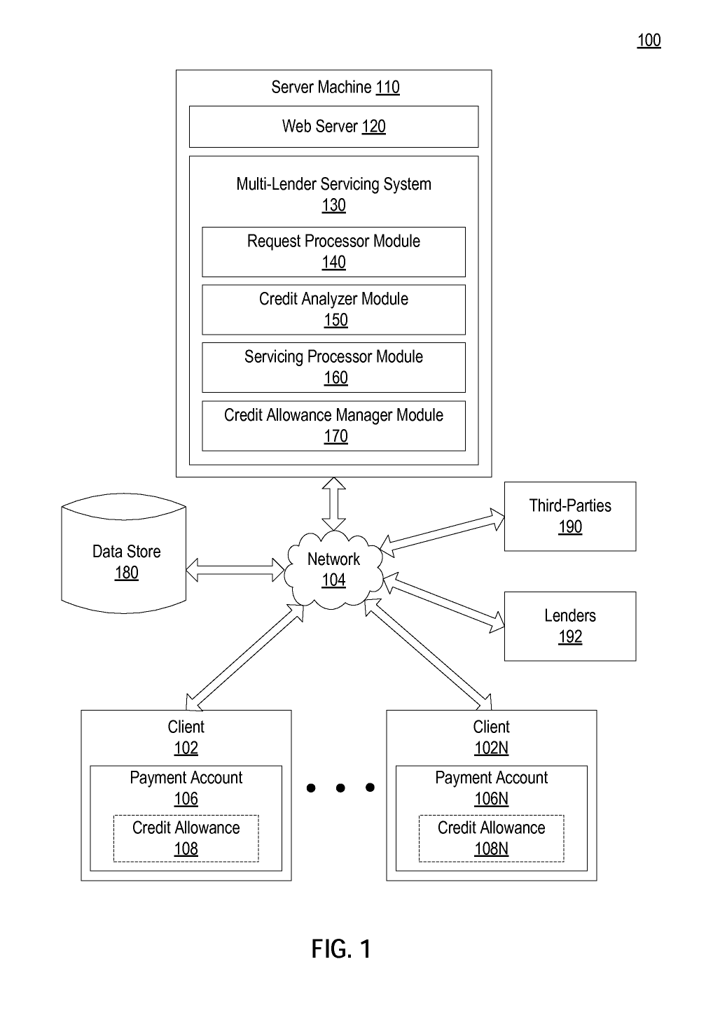

FIG. 1 illustrates an exemplary system architecture 100 in which examples of the present disclosure may be implemented. System architecture 100 includes a server machine 110, a data store 180, client machines 102A-102N, third-parties 190, and lenders 192 connected to a network 104. Network 104 may be a public network (e.g., the Internet), a private network (e.g., a local area network (LAN) or wide area network (WAN)), or a combination thereof. In an example, network 104 may include the Internet and/or one or more intranets, wired networks, wireless networks, and/or other appropriate types of communication networks. In one example, network 104 may comprise a wireless telecommunications network (e.g., cellular phone network) adapted to communicate with other communication networks, such as the Internet.

Data store 180 is persistent storage that is capable of storing various types of data, such as text, audio, video, and image content. In some examples, data store 180 might be a network-attached file server, while in other examples data store 180 might be some other type of persistent storage such as an object-oriented database, a relational database, and so forth.

Client machines 102A-102N may be personal computers (PC), laptops, mobile phones, tablet computers, server computers, wearable computing devices, or any other computing devices. Client machines 102A-102N may run an operating system (OS) that manages hardware and software of the client machines 102A-102N. A browser (not shown) may run on the client machines (e.g., on the OS of the client machines). The browser may be a web browser that can access content and services provided by a web server 120 of server machine 110. Other types of computer programs and computer scripts also may run on client machines 102A-102N.

Users of client machines 102A-102N each may have one or more payment accounts 106 associated with various merchants, marketplaces and/or payment service providers. In an example, a provider of a payment account 106 provides a credit allowance 108 for the payment account 106.

A payment account 106 generally refers to any type of account that allows a user to initiate payments, send payments, receive payments, and/or to send and receive credit, value, money, vouchers, compensation, or consideration. In some examples, payment accounts 106, 106N allow a user to register and utilize one or more payment methods, such as credit cards, debit cards, bank accounts, savings accounts, checking accounts, investment accounts, etc. Payment accounts 106 generally may be offered and provided by online payment service providers and other various forms of financial institutions.

A credit allowance 108 generally describes a maximum amount of credit or funds that a user may borrow from one or more lenders. A credit allowance 108 for a payment account 106 may be provided and serviced by one or more lenders 192. For example, a first lender 192 may provide a first portion of a credit allowance 108 (e.g., $300 of a $1000 credit allowance), a second lender 192 may provide a second portion of the credit allowance 108 (e.g., $200 of the $1000 credit allowance), a third lender 192 may provide a third portion of the credit allowance 108 (e.g., $100 of the $1000 credit allowance), and a portion of the credit allowance 108 may remain unused or available for later use.

In an example, any number of lenders 192 may provide and service various respective portions of a credit allowance 108 of a payment account 106 under separate terms and conditions agreed upon by each respective lender 192 and a user. Thus, a user, either independently or through a payment service provider, may freely contract with and utilize different lenders 192 in association with a credit allowance 108 of a payment account 106.

Lenders 192 generally describe any person, group, entity, or organization that provides cash or credit to a borrower with the expectation that borrowed funds will be repaid with interest and/or fees. The terms and conditions of a loan between a user and a lender 192 may include principal, repayment term, frequency of periodic repayment, interest rate, origination fees, penalty fees, etc. Examples of lenders 192 may include, but are not limited to, commercial banks, investment banks, insurance companies, brokerages, credit unions, payment service providers, merchants, retailers, universities, group funding, peer-to-peer lending, friends, family members, etc.

In an example, a payment provider may determine a credit allowance 108 to grant for a payment account 106 based on payment history and other information associated with the payment account 106. A user of the payment account 106 then may borrow against the credit allowance 108 to complete one or more transactions. For example, a user my use a credit allowance 108 of a payment account 106 to make a purchase from one third-party 190, to pay another third-party 190 for services, to donate money to a different third-party, etc. Third-parties 190 generally refer to any person, entity, or organization that is capable of sending and receiving payments.

Server machine 110 may be a rackmount server, a router computer, a personal computer, a portable digital assistant, a mobile phone, a laptop computer, a tablet computer, a camera, a video camera, a netbook, a desktop computer, a media center, or any combination thereof. Server machine 110 may include a web server 120 and a multi-lender servicing system 130. In some examples, web server 120 and multi-lender servicing system 130 may run on one or more different machines.

Web server 120 may provide text, audio, and video images from data store 180 to client machines 102A-102N. Web server 120 also may provide web-based application services, business logic, and/or multi-lender servicing system 130A, 130N updates to client machines 102A-102N. Client machines 102A-102N may locate, access, and consume various forms of content and services from web server 120 using applications, such as a web browser, web servers, application servers, computer programs, etc. Web server 120 also may receive text, audio, video, and image content from clients 102A-102N that is saved in data store 180 for purposes that may include preservation and distribution of content. Further, web server 120 and/or multi-lender servicing system 130 may receive API requests from various client machines 102A-102N.

In an example, web server 120 is coupled to one or more applications servers (not shown) that provide applications, services, and multi-lender servicing system 130 APIs to client machines 102A-102N. For example, web server 120 may provide clients 102A-102N with access to one or more application services of a multi-lender servicing system 130. Such functionality also may be provided, for example, as one or more different web applications, standalone applications, systems, plug-ins, web browser extensions, and application programming interfaces (APIs). In some examples, plug-ins and extensions also may be referred to, individually or collectively, as “add-ons.”

In an example, some client machines 102A-102N may include applications associated with a service provided by server machine 110. In one example, one or more device types (e.g., smart phones, smart televisions, tablet computers, wearable devices, smart home computer systems, etc.) may use applications to access content provided by, to issue commands to server machine 110, and/or to receive content from server machine 110 without visiting or using web pages.

In an example, functions performed by server machine 110 and/or web server 120 also may be performed by the client machines 102A-102N, in whole or in part. In addition, the functionality attributed to a particular component may be performed by different or multiple components operating together. Server machine 110 may be accessed as a service provided to other systems or devices via appropriate application programming interfaces (APIs), and thus is not limited to use with websites.

In an example, multi-lender servicing system 130 includes request processor module 140, credit analyzer module 150, servicing processor module 160, and credit allowance manager module 170. In some examples, functionality associated with request processor module 140, credit analyzer module 150, servicing processor module 160, and credit allowance manager module 170 may be combined, divided, and organized in various arrangements on one or more computing devices.

In an example, request processor module 140 of multi-lender servicing system 130 receives and processes various requests used to provide multi-lender servicing of a credit allowance 108. For example, request processor module 140 may receive various user requests to provide a credit allowance 108 for a respective user payment account 106. In one example, request processor module 140 receives requests to use a first portion of a credit allowance 108 for a transaction. Request processor module 140 also receives subsequent user requests to use one or more additional portions of a credit allowance 108 for different transactions. Request processor module 140 also may receive requests to update a credit allowance 108 for a payment account 106, for example, when a user wishes to increase or decrease a limit of a credit allowance 108.

In an example, credit analyzer module 150 of multi-lender servicing system 130 analyzes a payment history associated with a payment account 106 when determining whether to provide a credit allowance 108 for a payment account 106. Credit analyzer module 150 also may an amount of a credit allowance 108 based on analysis of payment history for a payment account 106. In some examples, credit analyzer 150 provides a credit allowance 108 and determines the amount of a credit allowance 108 in view of payment history for a payment account 106 without referencing a credit rating of the user.

In an example, servicing processor module 160 of multi-lender servicing system 130 solicits or requests various lender offers to service one or more portions of a credit allowance 108 for a payment account 106. In one example, servicing processor module 160 sends a request to each of a plurality of lenders to find one or more lenders interested in servicing a first portion of a credit allowance 108 that a user wishes to use in a transaction. Servicing processor module 160 also may send one or more additional requests to each of plurality of lenders to find one or more lenders interested in servicing other portions of credit allowance 108 that the user wishes to utilize in different transactions.

In an example, servicing processor module 160 receives one or more offers to finance a first portion of a credit allowance 108 of a user from at least one lender. Servicing processor module 160 then provides the one or more offers to finance the first portion of the credit allowance 108 to the user for evaluation. In some examples, the offers provided to a user for evaluation are filtered based on one or more user-provided criteria. For example, the offers provided to a user may wholly or partially match one or more servicing criteria requested by a user as part of a particular transaction.

In an example, servicing processor module 160 also receives one or more offers to finance a second portion of a credit allowance 108 of a user from at least one lender. In addition, servicing processor module 160 provides the one or more offers to finance the second portion of the credit allowance 108 to the user for evaluation. Further, servicing processor module 160 also may filter such lender offers based on one or more new or previously specified user criteria.

In an example, servicing processor module 160 receives a user's acceptance of an offer from a lender to finance a first portion of a credit allowance 108 for a payment account 106. Servicing processor 160 also may receive the user's acceptance of a different offer from another lender to finance a second portion (or any subsequent portion) of the credit allowance 108 for the payment account 106. Thus, a user may secure multiple lines of credit from different lenders under the same credit allowance 108.

In an example, each of the different lines of credit for a credit allowance 108 may be secured under the same terms and conditions or under completely different terms and conditions. For example, a first portion of a credit allowance 108 financed by one lender may have a different period, payment schedule, interest rate, and transaction fee in comparison to a second portion of a credit allowance 108 financed by a different lender under the same payment account 106 credit allowance 108. In addition, different portions of a credit allowance 108 also may differ in value and proportion.

In an example, credit allowance manager module 170 of multi-lender servicing system 130 provides a credit allowance 108 of a determined value for a payment account 106. Generally, a credit allowance 108 may be serviced by a plurality of lenders that each provides a separate line of credit to be applied against various portions or subsets of the credit allowance 108. For example, one or more terms and conditions of a first portion of a credit allowance 108 serviced by a first lender may differ in comparison to corresponding terms and conditions of a second portion of the credit allowance 108 serviced by a different lender.

In some examples, credit allowance manager module 170 notifies a user about a determined credit allowance 108 amount to be provided for a payment account 106. Credit allowance manager module 170 also may notify a user about adjustments to a credit allowance 108 or updates to available or remaining credit on a credit allowance 108 for a payment account 106.

In an example, credit allowance manager module 170 adjusts available or remaining credit for a credit allowance 108 in view of one or more lender offers accepted by a user on a payment account 106. In one example, credit allowance manager module 170 updates an amount of available credit for a credit allowance 108 in response to a user accepting a lender's offer to provide credit for a portion of a credit allowance 108 in association with a first transaction. Credit allowance manager module 170 also may update the amount of available credit for the same credit allowance 108 in response to the user accepting a different lender's offer to provide credit for another portion of a credit allowance 108 in association with a different transaction.

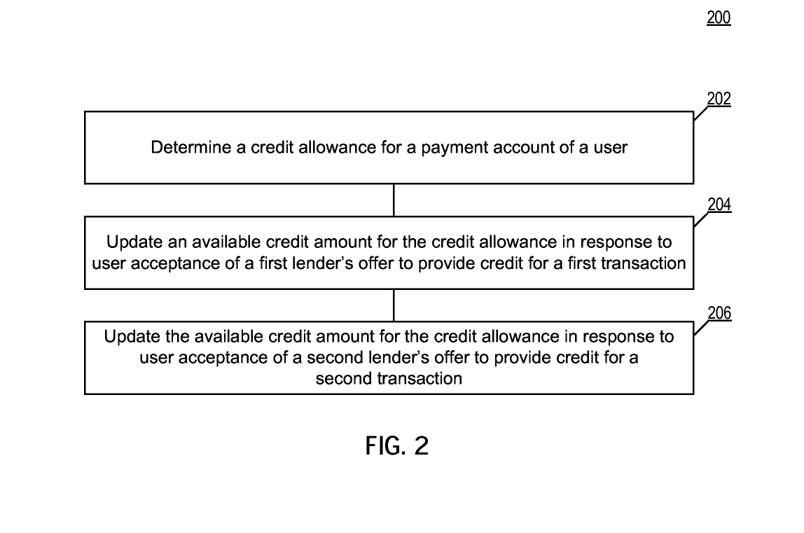

FIG. 2 is a flow diagram for providing multi-lender servicing of the same credit allowance 108, according to an example of the present disclosure. The method 200 may be performed by processing logic that may comprise hardware (circuitry, dedicated logic, programmable logic, microcode, etc.), software (such as instructions run on a general purpose computer system, dedicated machine, or processing device), firmware, or a combination thereof.

Method 200 begins at block 202 when request processor module 140 of multi-lender servicing system 130 determines a credit allowance 108 for a payment account 106 of a user. In some examples, a payment processor serving as an intermediary between one or more users and one or more lenders receives and processes various requests associated with multi-lender servicing of a credit allowance 108.

In an example, a request processor module 140 of a payment processor 130 receives a user request to provide a credit allowance 108 for a payment account 106. For example, a user may request a credit allowance 108 for a payment account 106 when creating the payment account 106, after creating the payment account 106, or as part of a transaction (e.g., a purchase, a cash withdrawal, a loan, a gift, a donation, etc.). In response, credit analyzer module 150 may analyze payment history for the payment account 106 to determine whether to provide the requested credit allowance 108.

In an example, credit analyzer module 150 determines a credit allowance 108 amount to provide for a payment account 106 based on analyzing payment history of the payment account 106. In some examples, credit analyzer module 150 uses payment history for a payment account 106 alone, without referencing a user's credit rating or other externally available information about a user when determining a credit allowance 108 for a payment account 106. Thus, a payment processor may make credit allowance 108 decisions pertaining to a user based on one or more of a user's purchases, payment information, and payment history. Therefore, in some examples, determination and establishment of a credit allowance 108 may not query or show on a user's credit report, which generally benefits the user.

In an example, request processor module 140 receives a request from a user to use a first portion of a credit allowance 108. For example, request processor module 140 may receive a request from a user seeking to purchase goods and/or services. In one example, a user initiates a request to use a first portion of a credit allowance 108 (e.g., $200 of a $1000 credit allowance) as part of an online checkout process to complete the purchase of goods and/or services. In some examples, credit analyzer module 150 may determine whether an amount of available credit for the credit allowance 108 is enough to complete a transaction and may offer a credit allowance 108 increase when an amount of available credit is insufficient for a transaction.

In an example, servicing processor module 160 creates and sends servicing requests to each of one or more lenders requesting bids to provide and service a line of credit for a credit allowance 108 of a payment account 106. For example, servicing processor module 160 may send a first set of servicing requests to lenders in response to receiving a user's request to use a first portion of a credit allowance 108.

In an example, servicing processor module 160 receives one or more bids from a first set of lenders to provide and service line of credit for a first portion of a credit allowance 108. In some examples, servicing processor module 160 may send servicing requests and receive bids as part of an online checkout process where a user seeks to complete a transaction using a portion of a credit allowance 108.

In an example, servicing processor module 160 transmits one or more of the bids received from a first set of lenders offering to provide a line of credit for a portion of a credit allowance 108 to a user. For example, servicing processor module 160 may return each of the lender bids to user for evaluation. In some examples, servicing processor module 160 provides one or more user interface controls (e.g., sliders, text boxes, numeric adjusters, checkboxes, etc.) that allow user to sort and/or filter presentation of one or more lender bids in a full or partial list of lender bids returned to the user. For example, servicing processor module 160 may provide a user with a user interface that allows the user to filter lender bids based on term, interest rate, down payment, penalties, fees, and/or other various terms and conditions.

In an example, request processor module 140 receives a new or subsequent request from a user to use another portion of a credit allowance 108 (e.g., $500 of $800 remaining on a credit allowance of $1000) to complete a second transaction (e.g., a different transaction than the first transaction described above). In response, servicing processor module 160 creates and sends a second set of servicing requests to each of one or more lenders requesting bids to provide and service a second line of credit for a credit allowance 108 of the payment account 106. Servicing processor module 160 then receives a second set of one or more bids from those lenders to provide and service the second line of credit for the credit allowance 108. Servicing processor module 160 then provides the second set of lender bids for the second portion of the credit allowance 108 to a user for evaluation. Servicing processor module 160 may filter and/or sort such bids based on one or more user-provided criteria (e.g., term, interest rate, down payment, penalties, fees, and/or other various terms and conditions).

At block 204, credit allowance manager module 170 of multi-lender servicing system 130 updates an available credit amount for the credit allowance 108 in response to user acceptance of a first lender's offer to provide credit for a first transaction. In an example, servicing processor module 160 receives user acceptance of a first lender's bid to provide and service a line of credit for a first portion of a credit allowance 108. For example, the user may accept a first lender's bid to provide a $200 line of credit from a $1000 credit allowance 108 under a first set of terms and condition, thus allowing the user to complete a first transaction.

In response, credit allowance manager module 170 updates an amount of available credit for the credit allowance 108, for example, by subtracting the first lender's line of credit from an available amount of credit on the credit allowance 108. In one example, credit allowance manager module 170 determines an available credit amount of $800 remains for a credit allowance 108 of $1000 having $1000 available credit after a user secures a $200 line of credit against the credit allowance 108 from a first lender.

At block 206, credit allowance manager module 170 of multi-lender servicing system 130 updates the available credit amount for the credit allowance 108 in response to user acceptance of a second lender's offer to provide a line of credit for a second portion of the credit allowance 108. In an example, servicing processor module 160 receives user acceptance of a second lender's bid to provide and service a new line of credit for a second portion of a credit allowance 108. For example, the user may accept a second lender's bid to provide a $500 line from $800 of available credit in a $1000 credit allowance 108 under a new set of terms and conditions to allow the user to complete a new pending transaction.

In response, credit allowance manager module 170 updates the amount of available credit for the credit allowance 108, for example, by subtracting the second line of credit from the second lender from an available amount of credit remaining on the credit allowance 108. For example, credit allowance manager module 170 may determine an available credit amount of $300 remains for a credit allowance 108 of $1000 with $800 of available credit after a user secures an additional $500 line of credit from a second lender to complete a second transaction.

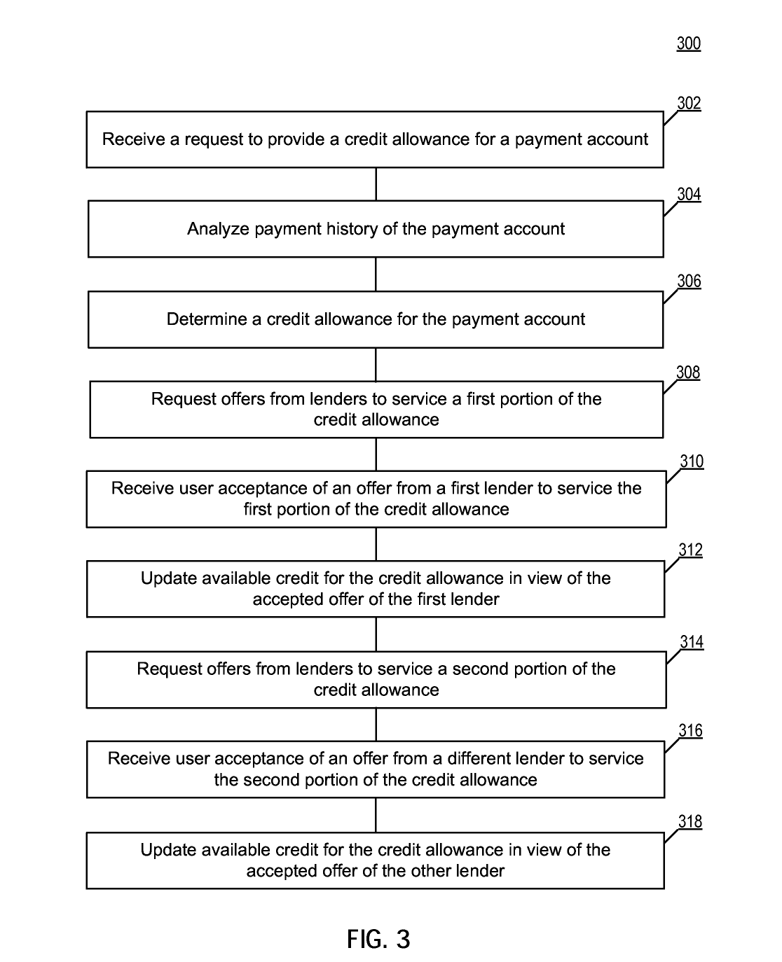

FIG. 3 is a flow diagram for performing processing of multi-lender servicing of the same credit allowance 108, according to an example of the present disclosure. The method 300 may be performed by processing logic that may comprise hardware (circuitry, dedicated logic, programmable logic, microcode, etc.), software (such as instructions run on a general purpose computer system, dedicated machine, or processing device), firmware, or a combination thereof.

Method 300 begins at block 302 when request processor module 140 of multi-lender servicing system 130 receives a request to provide a credit allowance 108 for a payment account 106. In some examples, request processor module 140 receives a request to provide a credit allowance 108 that is serviceable by different lenders that each provide respective portions of the credit allowance 108 at varying times under different terms and conditions as accepted by a user.

At block 304, credit analyzer module 150 of multi-lender servicing system 130 analyzes payment history of the payment account 106. In an example, credit analyzer module 150 analyzes one or more of purchase history, payment information, and payment history of a payment account 106 in response to a credit allowance 108 request. In one example, credit analyzer module 150 also requests and reviews one or more forms of various other external information, such as a credit rating, employment information, financial information, or other information associated with a user.

In an example, credit analyzer module 150 determines a proprietary credit indicator for a payment account 106 based on one or more of a purchase history, payment information, and payment history associated with the payment account 106. In some examples, the proprietary credit indicator is determined based on factors agreed upon by a payment processor and a network of lenders. Further, a payment processor may send a proprietary credit indicator for a payment account 106 to lenders in the lender network along with requests to service various portions of credit allowances 108.

At block 306, credit analyzer module 150 of multi-lender servicing system 130 determines a credit allowance 108 for the payment account 106. In an example, credit analyzer module 150 first determines whether to approve or deny a request for a credit allowance 108. Credit analyzer module 150 then determines a credit allowance 108 amount to provide to a payment account 106 of an approved credit allowance 108 request. For example, credit analyzer module 150 may determine the credit allowance 108 amount for a payment account 106 based one or more of a purchase history, payment information, and payment history of the payment account 106. Credit analyzer module 150 also may consider one or more factors external to the payment account 106, such as a credit rating, employment information, financial information, or other information associated with a user.

At block 308 servicing processor module 160 of multi-lender servicing system 130 requests offers from lenders to service a first portion of the credit allowance 108. In an example, servicing processor module 160 requests a first set of offers from lenders to service a first portion of a credit allowance 108. For example, servicing processor module 160 may request the first set of offers from the lenders in response to a request from a user to use a first portion of a credit allowance 108 available for a payment account 106. In some examples, servicing processor module 160 may provide one or more of a purchase history, payment information, and payment history associated with the payment account 106 to the lenders as part of the requests. Further, servicing processor module 160 may send a proprietary credit indicator for a payment account 106 to the lenders in the request.

At block 310, servicing processor module 160 of multi-lender servicing system 130 receives user acceptance of an offer from a first lender to service the first portion of the credit allowance 108. In an example, servicing processor module 160 provides a user with a list of one or more respective offers from a first set of lenders offering to service a first portion of a credit allowance 108. For example, servicing processor module 160 may provide a complete list of the offers, which the user then may sort and filter using a graphical user interface. Servicing processor module 160 also may pre-filter the offers provided to the user based on one or more user-provided criteria. For example, a user may specify one or more preferences relating to term (length), interest rate, penalty fees, transaction fees, and other various terms and conditions. Offers not wholly or partially matching a user's criteria may not be presented to the user. In an example, a user accepts a lender's offer to service the first portion of the credit allowance 108 by selecting the offer on a graphical user interface.

At block 312, credit allowance manager module 170 of multi-lender servicing system 130 updates available credit for the credit allowance 108 in view of the accepted offer of the first lender. In an example, credit allowance manager module 170 reduces an amount of available credit associated with a credit allowance 108 based user acceptance of a first lender's offer to provide a first portion of a credit allowance 108. Credit allowance manager module 170 also may increase an amount of available credit associated with the credit allowance 108, for example, based on full or partial repayment of the first portion of the credit allowance 108.

At block 314, servicing processor module 160 of multi-lender servicing system 130 requests offers from lenders to service a second portion of the credit allowance 108. In an example, servicing processor module 160 requests a second set of offers from lenders to service a second portion of a credit allowance 108. For example, servicing processor module 160 may request the second set of offers in response to a request from a user to use a second portion of a credit allowance 108.

At block 316, servicing processor module 160 of multi-lender servicing system 130 receives user acceptance of an offer from a different lender to service the second portion of the credit allowance 108. In an example, servicing processor module 160 provides a user with a list of one or more respective offers from a second set of lenders offering to service a second portion of a credit allowance 108. Servicing processor module 160 may provide a pre-filtered or complete list of the offers, which the user then may sort and further filter using a graphical user interface. A user then accepts one of the offers to service the second portion of the credit allowance 108, for example, to complete a transaction unrelated to the first portion of the credit allowance 108.

At block 318, credit allowance manager module 170 of multi-lender servicing system 130 updates available credit for the credit allowance 108 in view of the accepted offer of the other lender. In an example, credit allowance manager module 170 reduces the amount of available credit associated with a credit allowance 108 based user acceptance of a second lender's offer to provide a second portion of the credit allowance 108 at a time other when the first portion of the credit allowance 108 is provide by a different lender. Credit allowance manager module 170 also may increase the amount of available credit associated with the credit allowance 108, for example, based on full or partial repayment of the second portion of the credit allowance 108.

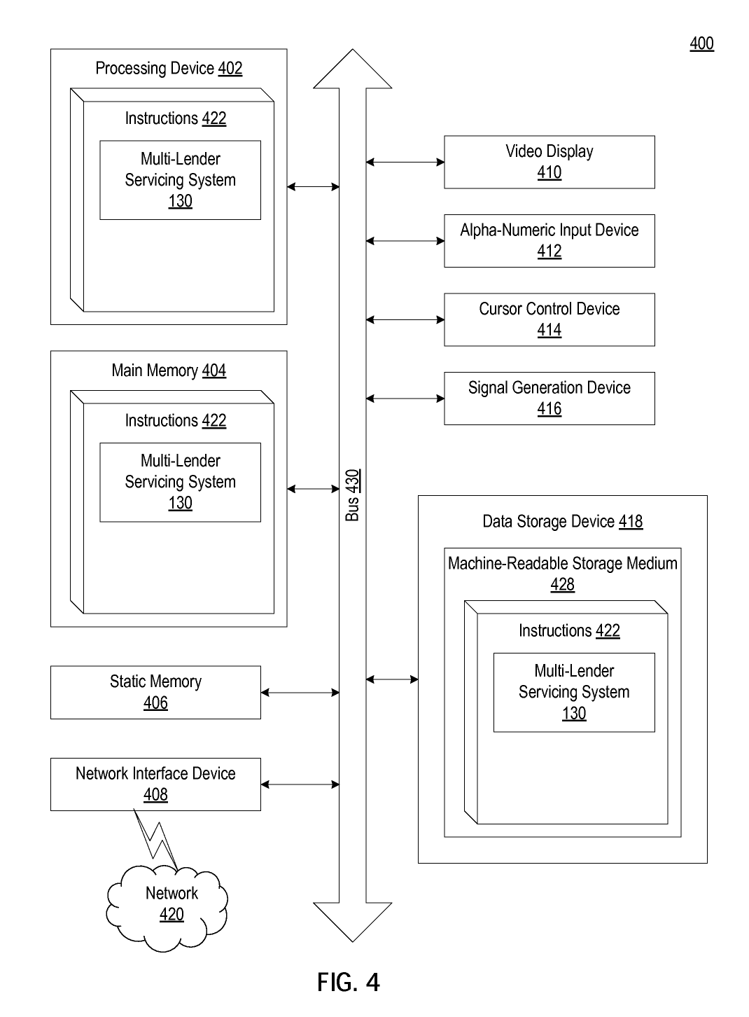

FIG. 4 illustrates a diagram of a machine in the exemplary form of a computer system 400, within which a set of instructions for causing the machine to perform any one or more of the methodologies discussed herein may be executed. In other examples, the machine may be connected (e.g., networked) to other machines in a LAN, an intranet, an extranet, or the Internet. The machine may operate in the capacity of a server or a client machine in client-server network environment, or as a peer machine in a peer-to-peer (or distributed) network environment. The machine may be a personal computer (PC), a tablet PC, a set-top box (STB), a Personal Digital Assistant (PDA), a cellular telephone, a wearable computing device, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 400 includes a processing device (processor) 402, a main memory 404 (e.g., read-only memory (ROM), flash memory, dynamic random access memory (DRAM) such as synchronous DRAM (SDRAM), double data rate (DDR SDRAM), or DRAM (RDRAM), etc.), a static memory 406 (e.g., flash memory, static random access memory (SRAM), etc.), and a data storage device 418, which communicate with each other via a bus 430.

Processor 402 represents one or more general-purpose processing devices such as a microprocessor, central processing unit, or the like. More particularly, the processor 402 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 402 also may be one or more special-purpose processing devices such as an application specific integrated circuit (ASIC), a field programmable gate array (FPGA), a digital signal processor (DSP), network processor, or the like. The processor 402 is configured to execute instructions 422 for performing the operations and steps discussed herein.

The computer system 400 also may include a network interface device 408. The computer system 400 may further include a video display unit 410 (e.g., a liquid crystal display (LCD) or a cathode ray tube (CRT)), an alphanumeric input device 412 (e.g., a keyboard), a cursor control device 414 (e.g., a mouse), and a signal generation device 416 (e.g., a speaker).

The data storage device 418 may include a computer-readable storage medium 428 on which is stored one or more sets of instructions 422 (e.g., software computer instructions) embodying any one or more of the methodologies or functions described herein. The instructions 422 also may reside, completely or at least partially, within the main memory 404 and/or within the processor 402 during execution thereof by the computer system 400, the main memory 404 and the processor 402 also constituting computer-readable storage media. The instructions 422 may be transmitted or received over a network 420 via the network interface device 408.

In one example, the instructions 422 include instructions for one or more modules of a multi-lender servicing system (e.g., multi-lender servicing system 130 of FIG. 1) and/or a software library containing methods that call a multi-lender servicing system 130. While the computer-readable storage medium 428 (machine-readable storage medium) is shown as an example to be a single medium, the term “computer-readable storage medium” should be taken to include a single medium or multiple media (e.g., a centralized or distributed database, and/or associated caches and servers) that store the one or more sets of instructions. The term “computer-readable storage medium” also may include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

Numerous details are set forth in the foregoing description. However, it will be apparent to one of ordinary skill in the art having the benefit of this disclosure that the present disclosure may be practiced without these specific details. In some instances, well-known structures and devices are shown in block diagram form, rather than in detail, to avoid obscuring the present disclosure.

Some portions of the detailed description have been presented in terms of algorithms and symbolic representations of operations on data bits within a computer memory. Here, an algorithm is generally conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “computing”, “comparing”, “associating”, “applying”, “transmitting”, “receiving,” “processing,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Certain examples of the present disclosure also relate to an apparatus for performing the operations herein. This apparatus may be constructed for the intended purposes, or it may comprise a general-purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

It is to be understood that the above description is intended to be illustrative, and not restrictive. Many other examples will be apparent to those of skill in the art upon reading and understanding the above description. The scope of the disclosure therefore should be determined with reference to the appended claims, along with the full scope of equivalents to which such claims are entitled.

What is claimed is:

1. A computer system, comprising:
a memory;
a processing device coupled to the memory;
a credit analyzer, executed by the processing device, to determine a credit allowance for a payment account of a user; and
a credit allowance manager, executed by the processing device, to:
update an available credit amount for the credit allowance in response to the user accepting an offer by a first lender to provide credit for a first transaction associated with the payment account; and
update the available credit amount of the credit allowance in response to the user accepting an offer by a second lender to provide credit for a second transaction associated with the payment account.

2. The computer system of claim 1, further comprising:
a request processor, executed by the processing device, to receive a request to provide a credit allowance for the payment account.

3. The computer system of claim 1, further comprising:
a credit allowance manager, executed by the processing device, to notify the user of the determined credit allowance for the payment account.

4. The computer system of claim 1, wherein the credit allowance is serviceable by a plurality of lenders each providing a separate line of credit to be applied against the credit allowance.

5. The computer system of claim 1, wherein one or more corresponding terms of the offer by the first lender and the offer by the second lender are different.

6. The computer system of claim 1, wherein the credit analyzer further:
analyzes a payment history associated with the payment account.

7. The computer system of claim 1, wherein the credit analyzer further:
determines the credit allowance in view of a payment history of the payment account.

8. The computer system of claim 1, wherein the credit analyzer determines the credit allowance without reference to a credit rating of the user.

9. The computer system of claim 1, further comprising:
a request processor, executed by the processing device, to receive a request from the user to use the first portion of the credit allowance for the first transaction; and
a servicing processor, executed by the processing device, to request offers from a plurality of lenders to service the first portion of the credit allowance requested by the user.

10. The computer system of claim 9, wherein the request to use the first portion of the credit allowance comprises one or more user criteria for servicing of the first portion of the credit allowance.

11. The computer system of claim 1, further comprising:
a request processor, executed by the processing device, to receive a request from the user to use the second portion of the credit allowance for the second transaction; and
a servicing processor, executed by the processing device, to request offers from a plurality of lenders to service the second portion of the credit allowance requested by the user.

12. The computer system of claim 1, further comprising:
a servicing processor, executed by the processing device, to receive one or more offers to service the first portion of the credit allowance from at least one lender.

13. The computer system of claim 1, further comprising:
a servicing processor, executed by the processing device, to receive one or more offers to service the second portion of the credit allowance from at least one lender.

14. The computer system of claim 1, further comprising:
a servicing processor, executed by the processing device, to provide one or more offers to service the first portion of the credit allowance to the user.

15. The computer system of claim 14, wherein the one or more offers to service the first portion of the credit allowance are filtered based on user-provided criteria.

16. The computer system of claim 1, further comprising:
a servicing processor, executed by the processing device, to provide one or more offers to service the second portion of the credit allowance to the user.

17. The computer system of claim 16, wherein the one or more offers to service the second portion of the credit allowance are filtered based on user-provided criteria.

18. The computer system of claim 1, further comprising:
a request processor, executed by the processing device, to determine an updated credit allowance for the payment account in view of additional payment history data available for the payment account.

19. A computer-implemented method, comprising:
determining, by a computer system, a credit allowance for a payment account of a user;
updating, by the computer system, an available credit amount for the credit allowance in response to the user's acceptance of an offer by a first lender to provide credit for a first transaction associated with the payment account; and
updating, by the computer system, the available credit amount for the credit allowance in response to the user's acceptance of an offer by a second lender to provide credit for a second transaction associated with the payment account.

20. A non-transitory computer-readable medium comprising computer-readable instructions that, when executed by one or more processors of a computer system, cause the one or more processors to perform operations comprising:
determining, by the computer system, a credit allowance for a payment account of a user;
updating, by the computer system, an available credit amount for the credit allowance in response to the user's acceptance of an offer by a first lender to provide credit for a first transaction associated with the payment account; and
updating, by the computer system, the available credit amount for the credit allowance in response to the user's acceptance of an offer by a second lender to provide credit for a second transaction associated with the payment account.
